(19) United States
(12) Patent Application Publication
(10) Pub. No.: US 2014/0089190 A1
(43) Pub. Date: Mar. 27, 2014

(54) CLAIM RATE BLACK BOX

(71) Applicant: BANK OF AMERICA CORPORATION, Charlotte, NC (US)

(72) Inventors: Arya Kumar Vedabrata, Bhubaneswar (IN); Reema Verma, Raipur (IN); Chandrasekhar Katuri, Hyderabad (IN); David Nathanael Hillis, Goodyear, AZ (US)

(73) Assignee: BANK OF AMERICA CORPORATION, Charlotte, NC (US)

(21) Appl. No.: 13/628,303

(22) Filed: Sep. 27, 2012

(51) Int. Cl. G06Q 20/40

(52) U.S. Cl. 705/44

(57) ABSTRACT

Apparatus for electronically modifying a rule-based relationship between bank and a merchant is provided. The apparatus may comprise a receiver configured to receive information relating to a plurality of merchant transactions and a plurality of claims associated with at least a portion of the merchant transactions. The apparatus may further comprise a processor configured to calculate a first value, the first value corresponding to a sum of the plurality of claims divided by a sum of the plurality of merchant transactions. The processor may be further configured to electronically divide the first value by an industry benchmark value. In the event that the resultant value is greater than a predetermined threshold value, the processor may be further configured to electronically modify a database storing data corresponding to rules defining the relationship between the bank and the merchant.

### FIELD OF TECHNOLOGY

This invention relates to a tool for use in monitoring a merchant's transaction behavior for a plurality of transaction channels. The plurality of transaction channels include debit card transactions, credit card transactions and automated clearing house transactions.

### BACKGROUND OF THE DISCLOSURE

Today, many merchants offer their customers the option of using a credit card to pay for goods and services. In the event that a customer uses his credit card for a payment, a request for funds is sent from a merchant's point of sale terminal to a merchant bank (also known as an acquirer bank). The request for funds may be sent to the merchant bank directly or via a Third Party Agent (TPA), referred to alternately hereinafter as a Merchant Services Provider (MSP). The merchant bank is a bank used by the merchant or the MSP to processes credit card transaction on behalf of the merchant.

After receipt of the request for funds, the merchant bank sends the request over a transaction processing network to a payment system. Exemplary payment systems include Visa™, MasterCard™, and American Express™. The payment system may subsequently transmit the request to an issuing bank. The issuing bank is a bank that has issued credit to the customer. In the event that the issuing bank determines that the customer has sufficient credit to cover the purchase amount, the issuing bank transmits an authorization message back over the network to the merchant bank. The merchant bank subsequently transmits the authorization message to the merchant.

Typically, a relationship between a merchant bank, an issuing bank and a merchant is mutually beneficial. The relationship is beneficial for the merchant because it enables the merchant to offer the convenience of credit card payments to his customers. Furthermore, the relationship is beneficial for both the merchant bank and the issuing bank because they are paid a processing fee for each transaction processed on behalf of the merchant.

However, this relationship may become undesirable for the merchant bank and/or the issuing bank. For example, a merchant's customers may frequently file claims with their issuing bank against a particular merchant. A customer's claim may dispute part or all of a credit card payment to the merchant for which the merchant had received an authorization from the issuing bank. In the event that the issuing bank determines the customer claim to be valid, the issuing bank reverses the financial liability of the transaction in dispute away from the customer and back to the merchant bank. This is known as a “chargeback.”

Chargebacks are undesirable for a merchant bank because they may result in one or more transaction networks levying heavy fines on the merchant bank. These fines are levied as a result of the merchant bank retaining one or more merchants with high chargeback frequencies. Chargebacks are further undesirable because the merchant bank may be unable to shift to the merchant the financial liability transmitted to him by the issuing bank.

Chargebacks are undesirable for an issuing bank because the issuing bank is forced to spend large amounts of time and money processing claims filed by their customers against merchants retained by one or more merchant banks Additionally, it is undesirable for the issuing bank to maintain a relationship with a merchant and/or a merchant bank with a statistically high number of claims and/or chargebacks because of possible fines and sanctions from various governmental bodies.

It would be desirable, therefore, to provide a tool for analyzing customer claim data filed against a merchant to assist a merchant bank and an issuing bank in determining whether or not to continue a relationship with the merchant.

However, not all chargebacks reflect negatively on a merchant. For example, customer claims may be based on errors outside of a merchant's control, such as transmission network errors and/or errors in a merchant bank's or issuing bank's electronic systems. Thus, at least a portion of claims filed against a merchant may not relate to the merchant's business practices.

It would be further desirable, therefore, to provide a tool for analyzing customer claim data filed against a merchant while identifying data that reflects the merchant's business practices.

### SUMMARY OF THE DISCLOSURE

Methods are provided for modifying a rule-based relationship between a bank and a merchant. The bank may be an issuing bank or an acquirer bank. One method, as disclosed herein, may include using a receiver to receive information relating to a plurality of fraudulent claims filed against a merchant during a predetermined time period and a total number of claims filed against the merchant during the predetermined time period. The method may also include using a processor to calculate a numerical value, the numerical value corresponding to a sum of the plurality of fraudulent claims divided by a sum of the total number of claims filed against the merchant. In the event that the numerical value is greater than a predetermined threshold value, the method may additionally include using the processor to electronically modify a database storing data corresponding to rules defining the relationship between the bank and the merchant.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows apparatus that may be used in accordance with the systems and methods of the invention;

FIG. 2 shows a flow diagram of a process that may be used in accordance with the systems and methods of the invention;

FIG. 3A shows a graphical display that may be output by the systems and methods of the invention;

FIG. 3B shows another graphical display that may be output by the systems and methods of the invention; and

FIG. 4 shows yet another graphical display that may be output by the systems and methods of the invention.

### DETAILED DESCRIPTION OF THE DISCLOSURE

The systems and methods of the invention relate to assisting a merchant bank and/or an issuing bank in identifying one or more merchant business practices. The systems and methods of the invention may additionally electronically modify a relationship between a merchant and a merchant bank and/or an issuing bank.

The invention may include a claim rate calculator. The claim rate calculator may analyze and output data relating to transactions executed by a merchant and claims filed by customers against the merchant. In some embodiments, the claim rate calculator may initiate a modification in a merchant-bank relationship based on one or more pieces of output data. In other embodiments, the claim rate calculator may identify electronic information indicative of a merchant's ethical origin and/or how, or if, to modify a merchant-bank relationship.

The claim rate calculator may be used by a merchant bank, an issuing bank, a third party, or any other business or association to analyze merchant transaction data. An exemplary usage of the systems and methods of the invention includes a merchant bank and/or an issuing bank using the invention as part of a Customer Due Diligence (CDD) process prior to acquisition of a merchant and/or as part of an ongoing CDD of an acquired merchant.

The claim rate calculator may be in electronic communication with one or more databases. One or more of the databases may include rules defining a relationship between a bank and a plurality of merchants. The databases may additionally include stored information corresponding to merchant transaction data for the plurality of merchants. The merchant transaction data may include electronic data corresponding to a number of electronic transactions executed by each merchant. The electronic transactions may include credit card transactions, debit card transactions, check transactions and/or ACH transactions. The merchant transaction data may additionally include data corresponding to claims filed by customers against one or more of the plurality of merchants. Each of the claims may be associated with the merchant transaction that the claim has disputed.

Furthermore, one or more of the databases may include information relating to lawsuits, claims, police records, newspaper articles, publications and/or any other suitable electronic data that may be used by the claim rate calculator to analyze and rank a merchant's and/or a merchant's employees' business practices.

The claim rate calculator may analyze and output data relating to transactions executed by a merchant and claims filed by customers against the merchant. Output data may include a merchant claim ratio, a benchmarked merchant claim ratio, a merchant fraudulent claim ratio and/or a benchmarked merchant fraudulent claim ratio. The ratios may be calculated by the claim rate calculator using one or more processors. The ratios may be indicative of a merchant's business practices.

In some embodiments, each of the merchant claim ratio, the benchmarked merchant claim ratio, the merchant fraudulent claim ratio and/or the benchmarked merchant fraudulent claim ratio may be calculated using transaction data from a single transaction channel. Exemplary transaction channels include credit card transactions, debit card transactions, check transactions and/or automated clearing house (“ACH”) transactions. Alternately, one or more of the aforementioned ratios may be calculated across-channel i.e., using transaction data from two or more transaction channels.

It should be noted that the equations disclosed herein for calculating the merchant claim ratio, the benchmarked merchant claim ratio, the merchant fraudulent claim ratio and/or the benchmarked merchant fraudulent claim ratio, as well as any all other equations disclosed in this patent application, are for exemplary purpose only. Any suitable equation may be used to calculate the aforementioned ratios and equations without departing from the scope of the invention.

The merchant claim ratio calculated by the claim rate calculator may be indicative of a percentage of a merchant's transactions that have generated customer claims. The merchant claim ratio may be calculated at least in part using the equation: (sum of a number of claims filed against a merchant)/(sum of a total number of transactions executed by the merchant during a predetermined time period).

The predetermined time period may be a day, a week, a month, two months, one year, a time period during which the merchant has been in business and/or any other suitable time period. In some embodiments, the clam rate calculator may align the predetermined time period with each transaction channel's regulatory and/or payment association maximum claim timeframe. An exemplary predetermined time period for a ratio including a debit card transaction channel and/or a credit card transaction channel may be 60 days, 90 days, 91 days or up to one year. An exemplary predetermined time period for a ratio including an ACH transaction channel may go back up to one year.

The claims included in the numerator of the merchant claim ratio may be claims actually filed against transactions included in the denominator of the merchant claim ratio (referred to alternately hereinafter as “the transaction set”). These claims may be claims filed during the predetermined time period. Alternately, in the event that there is a time lapse between the end of the predetermined time period and the calculation of the merchant claim ratio, these claims may include any claims, filed against the transactions set, up until the initiation of the calculation of the merchant claim ratio.

The claims included in the numerator of the merchant claim ratio may also include claims predicted to be filed against the transaction set. In these embodiments, the claim rate calculator may use one or more claims-specific quantitative models and/or algorithms to forecast a number of claims statistically likely to be filed against the transaction set within the time periods allowed by the regulatory rules governing the transaction channel(s) included in the transaction set. This prediction may be based on claim and transaction history data, in addition to the relevant channel's outstanding claimable transactions within a noted regulatory framework.

The predictive algorithms may exclude from the transaction set all or some large percentages of one or more subsets of transactions. An exemplary subset of transactions that may be excluded from the predictive algorithm's analysis may include transactions for which a merchant has already issued a credit/refund and/or transactions for which the issuance of a credit/refund is pending. An additional exemplary subset of transactions includes transactions for customers who are not allowed to file claims with their issuing bank. Such customers may be barred from filing claims with their issuing bank due to a high risk factor, prior friendly fraudster behavior, i.e., when a customer issues a chargeback through his issuing bank falsely claiming that he never received the goods/services purchased, and/or previous bad faith interactions with the issuing bank.

In some of these embodiments, the claim rate calculator may calculate an error value and an uncertainty value for a merchant claim ratio calculated using claims predicted to be filed against the merchant. This data may assist in determining a maximum risk that a merchant can potentially pose to a merchant bank and/or an issuing bank.

The merchant claim ratio may be benchmarked by the claim rate calculator. The benchmarked merchant claim ratio may be indicative of a merchant's claim rate relative to an industry's claim rate. The benchmarked merchant claim ratio may be calculated at least in part using the equation: (merchant claim ratio)/(industry claim ratio).

An exemplary industry claim ratio used to benchmark a merchant claim ratio may be calculated at least in part using the equation: (a sum of a total number of claims filed against merchants in an industry)/(a sum of a total number of transactions executed by the merchants in the industry during a predetermined time period). It should be noted that the industry data may be data associated with the same transaction channel(s) as the merchant claim ratio being benchmarked.

Industry data used to benchmark a merchant claim ratio may be data from one or more merchants associated with the same industry as the merchant whose data is being benchmarked. For example, the claim rate calculator may retrieve data from industry database(s) that corresponds to merchant transaction data for merchants with the same MCC or industry code as the merchant.

It should be noted that an industry code may relate to a four or six digit code defined by a governmental body and used to classify industries. Additionally, it should be noted that a MCC may be a code assigned to a business directly by MasterCard™ or Visa™ that classifies businesses by the type of goods and/or services that the business provides. Alternately, the MCC may be a code assigned to a business by a merchant or their merchant bank. However, it should be noted that such an assignment is equivalent to an indirect assignment by MasterCard™ or Visa™, since the merchant and the merchant bank are required to comply with MasterCard™ or Visa™ MCC selection standards.

In other embodiments, the claim rate calculator may consider one or more parameters other than industry type in order to group merchants for comparison to each other. For example, the claim rate calculator may define a peer group of merchants that materially compete with each other (also known as a ‘competitor set’) and use merchant transaction data from the defined peer group for benchmarking calculations. It should be noted that the merchants in the peer group may be merchants associated with a single industry or merchants across multiple industries.

The merchant fraudulent claim ratio calculated by the claim rate calculator may be indicative of a percentage of merchant transactions which have given rise to fraudulent claims against the merchant. In some embodiments, the merchant fraudulent claim ratio may be calculated at least in part using the equation: (sum of a total number of fraudulent claims filed against a merchant)/(sum of a total number of claims filed against the merchant).

The merchant fraudulent claim ratio may alternately be calculated at least in part using the equation: (sum of a total number of fraudulent claims filed against a merchant during a predetermined time period)/(sum of a total number of non-fraudulent claims filed against the merchant during the predetermined time period). Additionally, the merchant fraudulent claim ratio may be calculated at least in part using the equation: (sum of a total number of fraudulent claims filed against a merchant)/(sum of a total number of transactions executed by the merchant during the predetermined time period). It should be noted that the merchant fraudulent claim ratio may be calculated using transaction data associated with one or more transaction channels.

The fraudulent claims, non-fraudulent claims and total claims included in the merchant fraudulent claim ratio may be claims filed against a merchant during a predetermined time period. Alternately, the fraudulent claims, non-fraudulent claims and total claims may be claims actually filed and, in some embodiments, predicted to be filed against transactions included in a transaction set. The transaction set may include transactions generated by the merchant during a predetermined time period.

The claim rate calculator may determine if a claim is ‘fraudulent’ by analyzing stored data associated with the claim. In some embodiments, the claim rate calculator may determine if a claim is ‘fraudulent’ by searching a stored description of the claim for the word ‘fraud,’ a word that includes the letters ‘f-r-a-u-d’ and/or by searching the stored description for other words such as, for example, ‘deception,’ ‘scam,’ ‘con,’ ‘scheme,’ ‘swindle,’ ‘hoax,’ and/or ‘deceit.’ An example of a type of claim where a customer may use the word ‘fraud’ is a claim based on a merchant's unauthorized credit card transaction.

Alternately, the claim rate calculator may determine if a claim is ‘fraudulent’ based on a stored item type code associated with the claim. The item type code may be a code automatically or manually assigned to a claim during initial claim entry.

It should be noted that the claim rate calculator may apply some or all of the calculations described herein to chargeback information in place of claim information. In these embodiments, the claim rate calculator may use a reason code associated with a chargeback to determine if the chargeback is based on fraudulent merchant behavior or non-fraudulent merchant behavior. The reason code may be a code selected by personnel in a bank office of an issuing bank when initially processing a claim filed by the issuing bank's customer. For example, a chargeback with a reason code relating to fraudulent merchant behavior may be determined to be a ‘fraudulent’ chargeback by the systems and methods of the invention.

The claim rate calculator may benchmark the merchant fraudulent claim ratio. The benchmarked merchant fraudulent claim ratio may be indicative of a merchant's fraudulent claim ratio relative to an industry's fraudulent claim ratio. In some embodiments, the benchmarked merchant fraudulent claim ratio may be calculated at least in part using the following equation: (merchant fraudulent claim ratio)/(industry fraudulent claim ratio).

The industry fraudulent claim ratio may be calculated at least in part using the equation: (sum of a total number of fraudulent claims filed against merchants in an industry)/(sum of a total number of transactions executed by the merchants in the industry during a predetermined time period). Industry data used to benchmark a merchant fraudulent claim ratio may be data obtained from merchants associated with the same industry and/or merchants from the same peer group as the merchant being analyzed. It should be noted that the industry data may include data associated with one or more transaction channels. It should be noted that the industry data may be data associated with the same transaction channel(s) as the merchant fraudulent claim ratio being benchmarked.

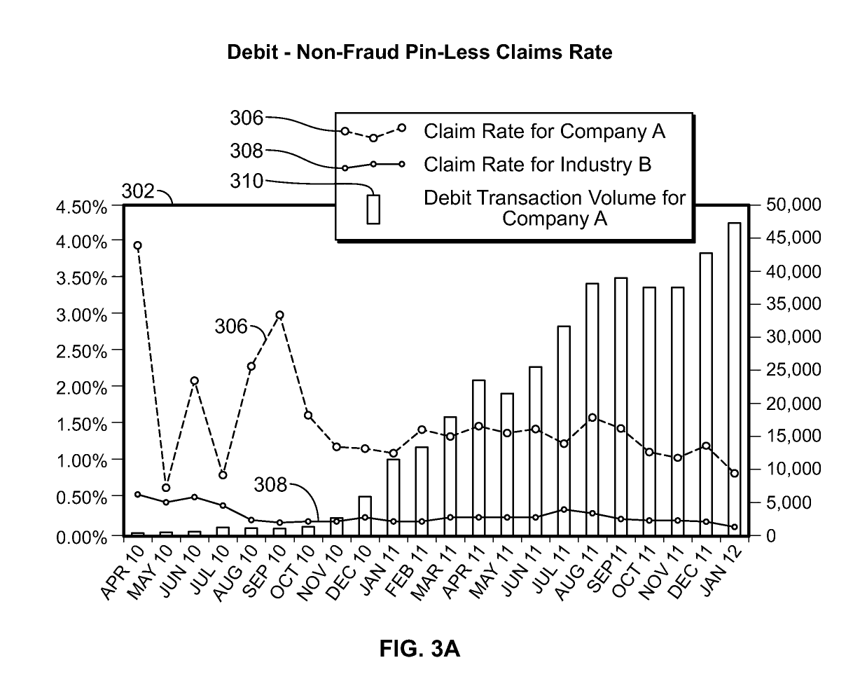

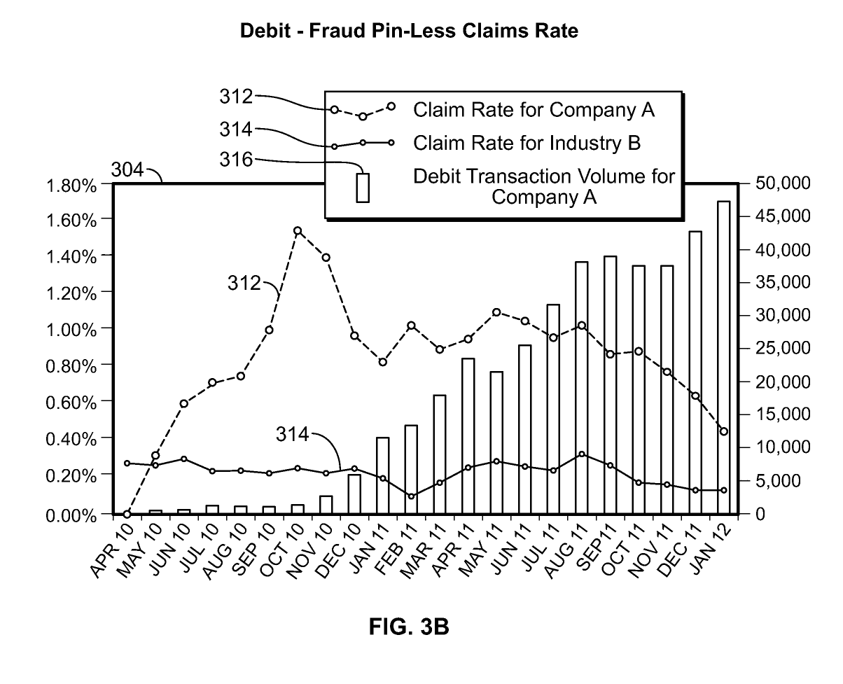

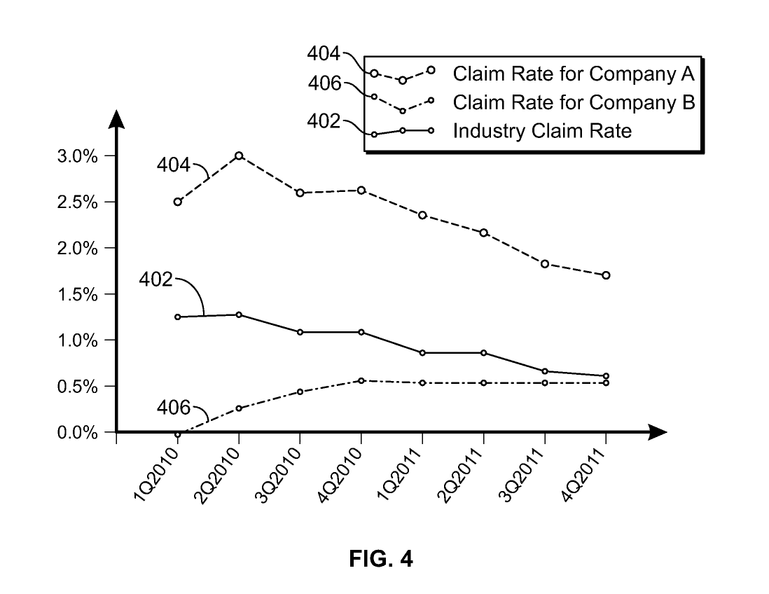

It should be noted that, in addition to the calculations performed by the claim rate calculator, the claim rate calculator may additionally compute and output one or more graphs or charts that illustrate at least a portion of the calculated data. For example, the claim rate calculator may graph on one or more graphs one or more merchant claim ratios and/or one or more industry claim ratios. Additional exemplary graphs output by the claim rate calculator are included in FIGS. 3A, 3B and 4.

The claim rate calculator may additionally include a claim rate database. The claim rate database may include stored data relating to a threshold value claim rate for one or more of the ratios calculated by the invention. The claim rate database may additionally include stored data relating to a threshold value for the increase of one or more ratios calculated by the invention.

The threshold values may be the same for all merchants. In other embodiments, the threshold values may differ between one or more merchants based on an industry and/or peer group that the merchant is affiliated with. In yet other embodiments, the threshold value may be adjusted based on merchant-specific data, such as how long a merchant has been in business and/or the volume/worth of the merchant's transactions to the merchant bank and/or issuer bank. This may be desirable because a merchant with a high volume of transactions may expose a merchant bank and/or an issuer bank to greater risk than a merchant with a low volume of transactions.

The claim rate calculator may calculate one or more of the aforementioned ratios for one or more merchants upon the lapse of a time interval. The time interval may be a day, a week, two weeks, a month, a time interval that aligns with a transaction channel's regulatory requirements and/or any other suitable time interval. Each of the ratios may be calculated upon the lapse of the same time interval or upon the lapse of different time intervals.

The claim rate calculator may save the ratios calculated for one or more merchants in a database. The claim rate calculator may subsequently compare the calculated ratios, in addition to rate(s) of increase or decrease of the calculated ratios, against the threshold values stored in the claim rate database. In the event that a merchant's claim rate or a rate of increase of a claim rate exceeds the respective threshold value by a quantitatively justified deviation, the claim rate calculator may implement one or more remedial measures. In some embodiments, the difference between the calculated claim rate and the threshold value claim rate may determine which, if any, remedial measures to implement.

Exemplary remedial action electronically initiated by the claim rate calculator may include electronically transmitting an electronic message to the merchant, the merchant bank, and/or the TPA. The electronic message may notify the recipient(s) of the data of the unacceptable claim data and/or claim rate and warn them to modify their business practices. The electronic message may additionally include a time period during which the merchant is expected to reform his behavior. The electronic message may also include text demanding that the merchant, merchant bank and/or TPA attend mandatory education classes. In some of these embodiments, attendance may be required during a predetermined time period to avoid initiation of remedial action.

Additional remedial action may include referral to a payment system for remediation or termination.

Additional remedial action may also include modifying an electronically-implemented rule-based relationship that exists between a merchant bank and/or an issuer bank and a merchant. For example, the claim rate calculator may electronically implement a processing delay for merchant transactions. Exemplary delays include an ACH delay, an interchange delay and a network processing delay. Additional exemplary delays include a 24-hour delay, or some other suitable delay, between a merchant's close of business on a business day and a batch processing of merchant transactions executed during the business day.

Additional remedial action may further include a direct termination by the merchant bank and/or the issuing bank of the merchant-bank relationship. This direct termination may be executed by the claim rate calculator by updating a database for authorizations. The update may establish that the bank will no longer authorize transactions for the merchant. In some embodiments, an authorized user may be required to electronically authorize the direct termination prior to its implementation.

In some embodiments, prior to direct termination, the claim rate calculator may electronically generate and transmit a cease and desist letter stored in a database to a merchant and/or a merchant bank. An exemplary letter to a merchant may state that the merchant has generated too many claims and, as a result, has been determined to be a threat to the payment system and will be shut down. An exemplary letter to a merchant bank (from an issuer bank) may state that the merchant bank has retained merchant(s) who have generated too many claims and demand that the merchant(s) be shut down, and/or state that the merchant bank-issuing bank relationship will be terminated.

Some merchants may have claim ratios that have not yet passed threshold values. However, these merchants may nevertheless have chronically high claim rates and/or claim volumes in one or more transaction channels. For such merchants, the claim rate calculator may closely monitor their behavior by calculating their claim ratios more frequently.

In some of these embodiments, the claim rate calculator may electronically transmit an electronic message to such merchants, stating that they are being watched. The electronic message may additionally refer the merchant(s) to a website for best practice tips, provide an offer to discuss mitigation approaches, receive customer analytics and/or provide detailed claim rate analyses.

It should be noted that, in the event that a merchant's claim rate previously exceeded a threshold value claim rate and now has been determined to be within an acceptable range of claim rate values, the claim rate calculator may discontinue one or more of the implemented remedial measures described above. However, if the claim rate is later calculated to again meet or exceed a threshold value claim rate, the remedial action taken by the claim rate calculator may be more severe and potentially permanent in nature.

The systems and methods of the invention may use merchant claim ratio data (i.e., one or more of a merchant claim ratio, benchmarked merchant claim ratio, merchant fraudulent claim ratio and/or benchmarked merchant fraudulent claim ratio) to identify merchants with unacceptable business practices. In some embodiments, the systems and methods of the invention may additionally or alternatively use other data to identify merchants with unacceptable business practices and/or merchants likely to engage in unacceptable business practices.

For example, the claim rate calculator may be configured to execute bad actor merchant due diligence (referred to alternately hereinafter as ‘BAM’). BAM may be executed as part of a CDD process prior to acquisition of a merchant and/or as part of an ongoing CDD of an acquired merchant. Alternately, BAM may be executed for a merchant in the event that one or more merchant claim ratios and/or merchant claim rates have surpassed a threshold value.

The claim rate calculator may execute BAM by searching for information corresponding to the merchant and/or the merchant's principles. Exemplary merchant principles include the merchant's CEO, board of directors, and management. In some embodiments, the claim rate calculator may additionally identify a network affiliated with the merchant and search for information relating to those included in the merchant's network. The network may include companies, businesses, and associations affiliated with the merchant, part of a multi-level marketing group associated with the merchant and/or part of a chain of multiple industries throughout the country that include the merchant. The network may additionally include the principles associated with these companies, businesses and associations.

After identification of the merchant(s) and/or principle(s) associated with the merchant and/or the merchant network, the claim rate calculator may search multiple databases to retrieve information indicative of the merchant(s) and/or principle(s) ethics. Exemplary information indicative of ethics may include information relating to illegal/unethical practices, association violations, negative press reports, lawsuits and/or being categorized as being ‘high risk’ by one or more third parties.

The multiple databases searched may be within one or more transaction channels. The databases may also be cross-industry databases. Cross-industry databases include databases maintained by banks, non-bank financial services, retailers, business & consumer credit bureaus and legal databases. Exemplary databases that may be used by the claim rate calculator include LexisNexis™ databases, high risk merchant categories generated by Visa™/MC™/Amex™ and any other lists in the industry that identify industries from which an acquirer will generally not on-board a merchant.

The claim rate calculator may process the data accessed during BAM and optionally take one or more forms of remedial action.

In some embodiments, retrieval of predetermined piece(s) of information may result in the electronic termination of a merchant-bank relationship. For example, in the event that a principle of a merchant was involved in fraud or has been convicted of a criminal offense, the claim rate calculator may electronically terminate a merchant-bank relationship.

In some embodiments, the processing may optionally include assigning a risk score to the merchant. The risk score may score a level of risk associated with the merchant based on the data obtained. The risk score may additionally be used to determine which form(s) of remedial action to take.

The risk score may take into account the impact of the information retrieved during BAM on a merchant's ethics. For example, certain pieces of information may not be indicative of a merchant's ethics, such as a small lawsuit between the merchant's principle and a neighbor. Additionally, a cease and desist letter may not be entirely determinative of a merchant's ethics if the case has not yet been litigated or settled.

The risk score may also take into account additional information relevant to a risk inherent in a merchant-bank relationship. Exemplary additional information includes whether there is a TPA/Agent Bank between the merchant bank and the merchant. Other exemplary additional information includes the nature of the relationship between the merchant and the bank. For example, in the event that the bank is the issuing bank, the risk score may take into account a projected net income that the bank will forfeit if it terminates the merchant-bank relationship.

BAM may also include categorizing a merchant as a ‘bad actor’ based on unacceptable merchant claim ratios, data accessed while searching the cross-industry databases and/or a merchant a risk score. It should be noted that a merchant determined to be a ‘bad actor’ in one transaction channel may be categorized as a ‘bad actor’ for all transaction channels.

In the event that a merchant is determined to be a ‘bad actor,’ the claim rate calculator may terminate a relationship between the merchant and a bank. In some embodiments, the claim rate calculator may subsequently terminate all relationships between the bank and other merchants associated/affiliated with the ‘bad actor’ merchant. Alternately, the claim rate calculator may take one or more forms of remedial action described herein to minimize the risk exposure of the issuing bank and/or the merchant bank.

Illustrative embodiments of apparatus and methods in accordance with the principles of the invention will now be described with reference to the accompanying drawings, which form a part hereof It is to be understood that other embodiments may be utilized and structural, functional and procedural modifications may be made without departing from the scope and spirit of the present invention.

As will be appreciated by one of skill in the art upon reading the following disclosure, the claim rate calculator may be embodied as a method, a data processing system, or a computer program product. Accordingly, the claim rate calculator may take the form of an entirely hardware embodiment, an entirely software embodiment or an embodiment combining software and hardware aspects.

Furthermore, the claim rate calculator may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

In an exemplary embodiment, in the event that the claim rate calculator is embodied at least partially in hardware, the claim rate calculator may include one or more databases, receivers, transmitters, processors, modules including hardware and/or any other suitable hardware. Furthermore, the operations executed by the claim rate calculator may be performed by the one or more databases, receivers, transmitters, processors and/or modules including hardware.

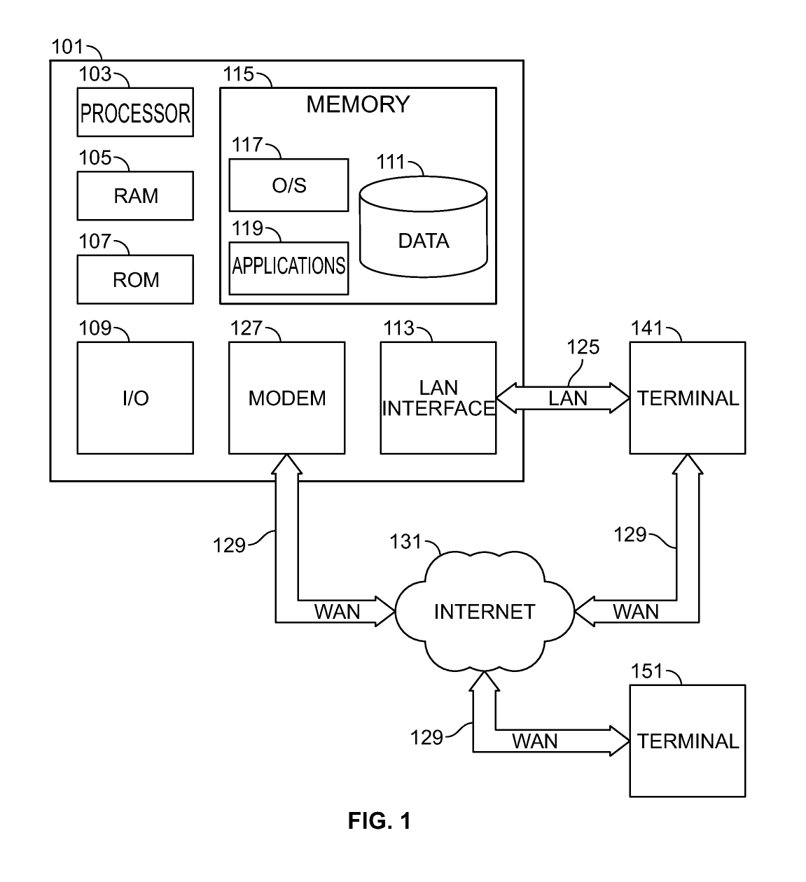

FIG. 1 is a block diagram that illustrates a generic computing device 101 (alternately referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternately, some or all of server 101 computer executable instructions may be embodied in hardware or firmware (not shown). As described in detail below, database 111 may provide storage for information input into the claim rate calculator.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by a user of the claim rate calculator to access and input information into the claim rate calculator. Information input into the claim rate calculator may be stored in memory 115. The input information may be processed by an application such as one of applications 119.

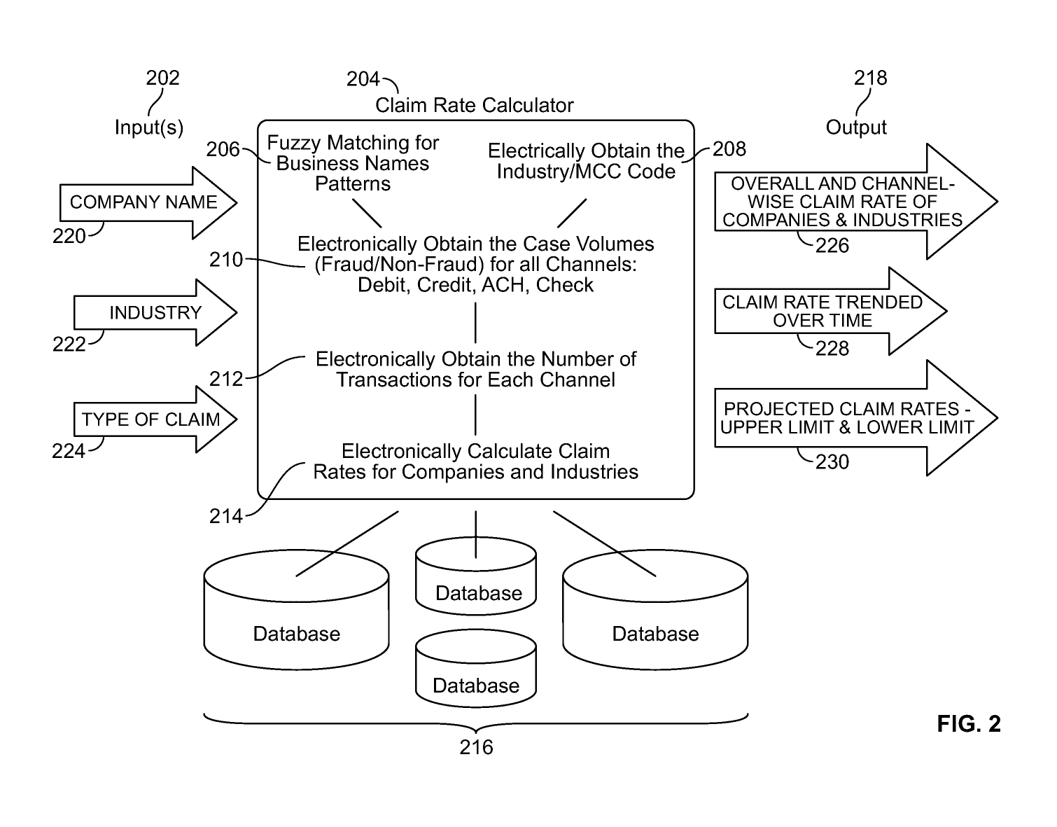

FIG. 2 shows a flow diagram of an exemplary process that may be used in accordance with the systems and methods of the invention. The exemplary process illustrated in FIG. 2 may include steps 202-214 and 218.

The exemplary process in FIG. 2 may include step 202. At step 202, information relating to one or more of Company Name 220, Industry 222 and/or Type of claim 224 may be input into claim rate calculator 204.

At step 206, claim rate calculator 204 may use fuzzy matching for business name patterns to obtain data associated with Company Name 220. It should be noted that claim rate calculator 204 may also look for perfect matches to obtain data associated with Company Name 220. The data may be obtained from one or more of Databases 216. At step 208, claim rate calculator 204 may electronically obtain the industry code/MCC associated with Company Name 220.

At step 210, claim rate calculator 204 may electronically obtain the case volumes (fraud/non-fraud) for a variety of channels, such as debit, credit, ACH and/or check. At least a portion of this information may be obtained from one or more of databases 216. At step 212, claim rate calculator 204 may electronically obtain the number of transactions for each channel. At least a portion of this information may also be obtained from one or more of databases 216.

At step 214, claim rate calculator 204 may electronically calculate claim rates for one or more companies and/or industries. Claim rate calculator 204 may electronically calculate the claim rates for the companies and/or industries using one or more of the claim rate calculations described above. It should be noted that at least a portion of the calculated claim rates may include claim rates for a company associated with Company Name 220. It should additionally be noted that at least a portion of the calculated claim rates may also include claim rates for the industry that Company Name 220 is associated with and/or companies associated with the same MCC as Company Name 220.

At step 218, claim rate calculator 204 may output a variety of information. A portion of the output information may include Overall and Channel-Wise Claim Rate of Companies & Industries 226, Claim Rate Trended Over Time 228 and/or Projected Claim Rates—Upper Limit & Lower Limit 230. In some embodiments, the GUIs displayed in FIGS. 3A, 3B and 4 may be included in the information output by claim rate calculator 204.

FIG. 3A shows an illustrative graphical display that may be output by the systems and methods of the invention. For example, the graphical display illustrated in FIG. 3A may be a portion of the information output by claim rate calculator 204.

The graphical display illustrated in FIG. 3A may include graph 302. Graph 302 may graph Claim Rate for Company A 306, Claim Rate for Industry B 308 and Debit Transaction Volume for Company A 310. Graph 302 may graph the aforementioned information between the dates of April 2010 and January 2012.

Claim Rate for Company A 306 and Claim Rate for Industry B 308 may relate to claims filed by customers with their issuing bank that dispute debit pin-less transactions. Additionally, Claim Rate for Company A 306 and Claim Rate for Industry B 308 may relate to claims filed by customers with their issuing bank that are categorized as “non-fraud claims” by the claim rate calculator 204. The claim rate calculator 204 may categorize a claim as a non-fraud claim by one or more of the methods described above.

Claim Rate for Company A 306 may correspond to a percentage of Company A's debit pin-less transactions that gave rise to non-fraud claims against Company A during a given month. For example, in May 2010, 0.60% of the debit pin-less transactions performed by Company A gave rise to non-fraud claims against Company A.

Claim Rate for Industry B 308 may correspond to a percentage of debit pin-less transactions executed by companies associated with Industry B that gave rise to non-fraud claims against the companies during a given month. For example, in May 2010, 0.40% of debit pin-less transactions executed by companies associated with Industry B gave rise to non-fraud claims. It should be noted that, in some embodiments, Industry B may be an industry that Company A is associated with. For example, Industry B may be an industry with the same industry code and/or MCC as Company A. It follows that the companies associated with Industry B may be all the companies or a subset of the companies with the same Industry Code and/or MCC as Industry B.

Debit Transaction Volume for Company A 310 may correspond to a total volume of debit pin-less transactions executed by Company A during a given month. For example, in June 2011, Company A executed 25,000 debit transactions.

FIG. 3B shows another illustrative graphical display that may be output by the systems and methods of the invention. For example, the graphical display illustrated in FIG. 3B may be a portion of the information output by claim rate calculator 204.

The graphical display illustrated in FIG. 3B may include graph 304. Graph 304 may graph Claim Rate for Company A 312, Claim Rate for Industry B 314 and Debit Transaction Volume for Company A 316. Graph 304 may graph the aforementioned information between the dates of April 2010 and January 2012.

Claim Rate for Company A 312 and Claim Rate for Industry B 314 may relate to claims filed by customers with their issuing bank that dispute debit pin-less transactions. Additionally, Claim Rate for Company A 312 and Claim Rate for Industry B 314 may relate to claims filed by customers with their issuing bank that are categorized as “fraud claims” by the claim rate calculator 204. The claim rate calculator 204 may categorize a claim as a fraud claim by one or more of the methods described above.

Claim Rate for Company A 312 may correspond to a percentage of Company A's debit pin-less transactions that gave rise to fraud claims against Company A during a given month. For example, in May 2010, 0.30% of the debit pin-less transactions performed by Company A gave rise to fraud claims against Company A.

Claim Rate for Industry B 314 may correspond to a percentage of debit pin-less transactions executed by companies associated with Industry B that gave rise to fraud claims against the companies during a given month. For example, in May 2010, 0.25% of debit pin-less transactions executed by companies associated with Industry B gave rise to fraud claims.

Debit Transaction Volume for Company A 316 may correspond to a total volume of debit pin-less transactions executed by Company A during a given month. For example, in June 2011, Company A executed 25,000 debit transactions.

FIG. 4 shows an illustrative graphical display that may be output by the systems and methods of the invention. For example, the graphical display illustrated in FIG. 4 may be a portion of the information output by claim rate calculator 204.

The graphical display illustrated in FIG. 4 graphs Industry C Claim Rate 402, Claim Rate for Company A 404 and Claim Rate for Company B 406. It should be noted that Company A and Company B may be companies associated with Industry C. It should additional be noted that, in some embodiments, the claim information used to calculate Company A's claim rate, Company B's claim rate and Industry C's claim rate may be claim information from a specific channel (e.g. claims arising out of debit transactions, credit transactions, ACH transactions or check transactions). In other embodiments, the claim information used may correspond to claim information from one or more channels. In yet other embodiments, the claim information used may correspond to all claims filed against Company A, Company B and Industry C.

Industry C Claim Rate 402 may correspond to a percentage of transactions executed by companies included in Industry C that gave rise to claims against the companies during a given quarter. For example, in the first quarter of 2011, 0.8% of transactions executed by companies included in Industry C gave rise to claims.

Claim Rate for Company A 404 may correspond to a percentage of transactions executed by company A during a given quarter that gave rise to claims against Company A. Claim Rate for Company B 406 may correspond to a percentage of transactions executed by company B during a given quarter that gave rise to claims filed against Company B.

FIG. 4 shows an advantage of comparing a company's claim rate against an industry's claim rate. Specifically, Company A's claim rate, if considered by itself, would seem to reflect positively on Company A. This is at least because Company A's claim rate is shown to have been decreasing since the third quarter of 2010. However, by comparing Company A's claim rate to Industry C's claim rate using the systems and methods of the invention, it becomes apparent that although Company A's claims are decreasing, Company A's claim rate is still significantly above the claim rate average in their industry. Additionally, Company B's claim rate, if it considered by itself, would seem to reflect negatively on Company B. This is at least because Company B's claim rate is shown to have been increasing since the first quarter or 2010. However, by comparing Company B's claim rate to Industry C's claim rate using the systems and methods of the invention, it becomes apparent that although Company B's claims are increasing, Company B's claim rate is still below the industry average.

Thus, the systems and methods of the invention allow a bank to make meaningful decisions based on a merchant's claim rate by comparing it to the industry benchmark.

Thus, methods and apparatus for processing information corresponding to claims filed against one or more merchants in accordance with the systems and methods of the invention have been provided. Persons skilled in the art will appreciate that the present invention can be practiced in embodiments other than the described embodiments, which are presented for purposes of illustration rather than of limitation, and that the present invention is limited only by the claims that follow.

1. Apparatus for electronically modifying a rule-based relationship between a bank and a merchant, the apparatus comprising:
a receiver configured to receive information relating to a plurality of merchant transactions executed by the merchant and a plurality of claims associated with the merchant transactions;
a processor configured to calculate a first value, the first value corresponding to a sum of the plurality of claims divided by a sum of the plurality of merchant transactions;
the processor being further configured to electronically divide the first value by a second value, the second value corresponding to an industry benchmark, wherein the industry benchmark is calculated using the equation (sum of a plurality of claims filed against a group of merchants, the merchant and each member of said group of merchants being associated with a single merchant category code)/(sum of a plurality of transactions executed by the group of merchants); and
if a quotient obtained from the division of the first value by the second value is greater than a predetermined threshold value, the processor is further configured to update an authorization database, wherein the update establishes a denial, by the bank, to authorize all future merchant transactions executed by the merchant.

2. The apparatus of claim 1 wherein the plurality of claims received by the receiver include claims filed against one or more of the plurality of merchant transactions.

3. The apparatus of claim 2 wherein the plurality of claims received by the receiver include claims statistically likely to be filed against one or more of the plurality of merchant transactions.

4. The apparatus of claim 3 wherein the processor is further configured to calculate the claims statistically likely to be filed against one or more of the plurality of merchant transactions using a quantitative model.

5. The apparatus of claim 1 wherein the plurality of merchant transactions received by the receiver are a plurality of merchant transactions executed by the merchant during a predetermined time period.

6. The apparatus of claim 1 wherein the plurality of merchant transactions received by the receiver are a plurality of merchant transactions associated with a single transaction channel.

7. The apparatus of claim 6 wherein the transaction channel is an automated cleaning house transaction channel.

8. The apparatus of claim 5 wherein the plurality of transactions executed by the group of merchants are executed during the predetermined time period.

9. One or more non-transitory computer-readable media storing computer-executable instructions which, when executed by a processor on a computer system, perform a method for modifying a rule-based relationship between a bank and a merchant, the method comprising:
using a receiver to receive information relating to a number of fraudulent claims filed against the merchant and a number of transactions executed by the merchant during a predetermined time period;
using a processor to calculate a numerical value, the numerical value being calculated at least in part by dividing the number of fraudulent claims by the number of transactions executed by the merchant; and
in the event that the numerical value is greater than a predetermined threshold value, using the processor to electronically modify stored data defining a relationship between the bank and the merchant.

10. The computer-readable media of claim 9, Wherein the processor is a first processor, further comprising a second processor configured to retrieve fraudulent claim data from one or more databases and transmit the fraudulent claim data to the receiver, wherein the second processor identifies the fraudulent claim data by searching the databases for claims filed against the merchant that include the word ‘fraud.’

11. The computer-readable media of claim 9, wherein the processor is a first processor, further comprising a second processor configured to retrieve fraudulent claim data from one or more databases and transmit the fraudulent claim data to the receiver, wherein the second processor identifies the fraudulent claim data by searching the databases for claims associated with an item type code that is indicative of fraudulent merchant behavior.

12. The computer-readable media of claim 9, wherein the numerical value is a first value, further comprising using the processor to electronically divide the first value by a second value, the second value corresponding to an industry fraudulent benchmark, wherein the industry fraudulent benchmark is calculated using the equation (a number of fraudulent claims filed against a group of merchants, each member of said group associated with an industry code that is the same industry code associated with the merchant)/(sum of a plurality of transactions executed by the group of merchants during the predetermined period).

13. The computer-readable media of claim 12, wherein the predetermined threshold is a first predetermined threshold, using the processor to electronically modify the stored data defining the relationship between the bank and the merchant in the event that the division of the first value by the second value exceeds a second predetermined threshold.

14. The computer-readable media of claim 9 wherein, in the method, the number of fraudulent claims are a number of fraudulent claims filed against transactions executed by the merchant during the predetermined time period.

15. The computer-readable media of claim 9 wherein, in the method, the number of transactions executed by the merchant are transactions associated with a transaction channel.

16. The computer-readable media of claim 15 wherein, in the method, the transaction channel is one of a credit card transaction channel, debit card transaction channel and check transaction channel.

17. The computer-readable media of claim 16 wherein, in the method, the predetermined time period is a time period associated with the transaction channel's maximum claim timeframe.

18. The computer-readable media of claim 9 wherein, in the method, the threshold value is greater than an industry value.

19. The computer-readable media of claim 18 wherein, in the method, the industry value is calculated by the processor at least in part using the equation (a number of fraudulent claims filed against a group of merchants, each member of said group associated with a merchant category code that is the same merchant category code associated with the merchant)/(sum of a plurality of transactions executed by the group of merchants during the predetermined period).

20. The computer-readable media of claim 9 wherein, in the method, the electronic modification establishes a denial, by the bank, to authorize all future merchant transactions executed by the merchant.
